(19) United States
(12) Patent Application Publication
(10) Pub. No.: US 2011/0069344 A1
(43) Pub. Date: Mar. 24, 2011

(54) INFORMATION PROCESSING APPARATUS, CONTROL METHOD THEREOF, AND STORAGE MEDIUM

(75) Inventor: So Yokomizo, Kawasaki-shi (JP)

(73) Assignee: CANON KABUSHIKI KAISHA, Tokyo (JP)

(21) Appl. No.: 12/862,514

(22) Filed: Aug. 24, 2010

(30) Foreign Application Priority Data
Sep. 18, 2009 (JP) 2009-218005

(51) Int. Cl. G06F 3/12

(52) U.S. Cl. 358/1.15

(57) ABSTRACT

This invention provides an information processing apparatus that reduces user operations and also the processing load on an image forming apparatus upon instructing the image forming apparatus to execute pull-print processing, and a control method thereof. To accomplish this, the information processing apparatus is connected to an image forming apparatus that stores a plurality of files to be image formed. If the image forming apparatus can interpret the format of the file, the information processing apparatus issues an image forming instruction to the image forming apparatus by designating the storage location of that file. On the other hand, if the image forming apparatus cannot interpret the format of the file, the information processing apparatus transmits data obtained by converting the file into an interpretable format, and issues an image forming instruction of that data to the image forming apparatus.

### BACKGROUND OF THE INVENTION

1. Field of the Invention

The present invention relates to an information processing apparatus connected to an image forming apparatus having a file server of, for example, documents, a control method thereof, and a storage medium.

2. Description of the Related Art

In a system having a PC, file server, and printer, which are connected to a network, print processing of a document file on the file server is normally implemented by opening the document file on the PC, and issuing a print instruction from the PC to the printer. Japanese Patent Laid-Open No. 11-24861 has proposed a system in which a printer directly refers to a document file on a file server so as to reduce the network load at the time of print processing. More specifically, when a PC issues a print instruction of a document file on the file server to the printer, the printer interprets information of the print instruction, accesses the file server to acquire the document file, and executes print processing. Such print processing will be referred to as pull-print processing hereinafter.

However, the related art suffers the following problems. For example, the related art requires settings that allow the printer to recognize the file server on the network. Also, since a file has to be transferred (acquired) at the time of print processing, a print performance drops when a printer has a low network processing performance. Furthermore, when the user wants to print a document file on the file server, he or she has to explicitly designate a pull-print mode in place of a normal print mode, thus posing problems of necessity of PC settings and troublesome operations.

### SUMMARY OF THE INVENTION

The present invention enables realization of an information processing apparatus that reduces user operations as well as the processing load on an image forming apparatus upon instructing the image forming apparatus to execute pull-print processing, a control method thereof, and a storage medium.

One aspect of the present invention provides an information processing apparatus connected to an image forming apparatus which stores a plurality of files, the information processing apparatus comprising: an acceptance unit that accepts, from a user, an image forming instruction of a file stored in the image forming apparatus; a determination unit that determines whether or not the image forming apparatus is configured to interpret a format of the file, the image forming instruction of which is accepted; and an instruction unit that issues, when the image forming apparatus is configured to interpret the format of the file, an image forming instruction to the image forming apparatus by designating a storage location of the file in the image forming apparatus without acquiring the file from the image forming apparatus, and converts, when the image forming apparatus is not configured to interpret the format of the file, the file acquired from the image forming apparatus into a format that the image forming apparatus is configured to interpret, transmits the converted data to the image forming apparatus, and issues an image forming instruction of the converted data to the image forming apparatus.

Another aspect of the present invention provides a control method of an information processing apparatus connected to an image forming apparatus which stores a plurality of files to be image formed, the method executing: controlling an acceptance unit to accept, from a user, an image forming instruction of a file stored in the image forming apparatus; controlling a determination unit to determine whether or not the image forming apparatus is configured to interpret a format of the file, the image forming instruction of which is accepted; and controlling an instruction unit to issue, when the image forming apparatus is configured to interpret the format of the file, an image forming instruction to the image forming apparatus by designating a storage location of the file in the image forming apparatus without acquiring the file from the image forming apparatus, and to convert, when the image forming apparatus is not configured to interpret the format of the file, the file acquired from the image forming apparatus into a format that the image forming apparatus is configured to interpret, transmit the converted data to the image forming apparatus, and issue an image forming instruction of the converted data to the image forming apparatus.

Still another aspect of the present invention provides a computer-readable storage medium storing a computer program for making a computer execute a control method of the information processing apparatus.

Further features of the present invention will be apparent from the following description of exemplary embodiments with reference to the attached drawings.

### BRIEF DESCRIPTION OF THE DRAWINGS

FIG. 1 is a diagram showing an example of the arrangement of an information processing system 100 and printer 1 according to the first embodiment;

FIG. 2A is a block diagram showing an example of the arrangement of a controller unit 110 of the printer 1 according to the first embodiment;

FIG. 2B is a block diagram showing an example of the arrangement of a PC 3 according to the first embodiment;

FIG. 3 is a view showing the processing sequence of a document file according to the first embodiment;

FIG. 4 is a flowchart showing the installation sequence of a printer driver according to the first embodiment;

FIG. 5 is a flowchart showing the processing sequence of print processing according to the first embodiment;

FIG. 6 is a flowchart showing the processing sequence of print processing according to the second embodiment; and

FIG. 7 is a flowchart showing the processing sequence of print processing according to the third embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

<Arrangement of Information Processing System and Image Forming Apparatus>

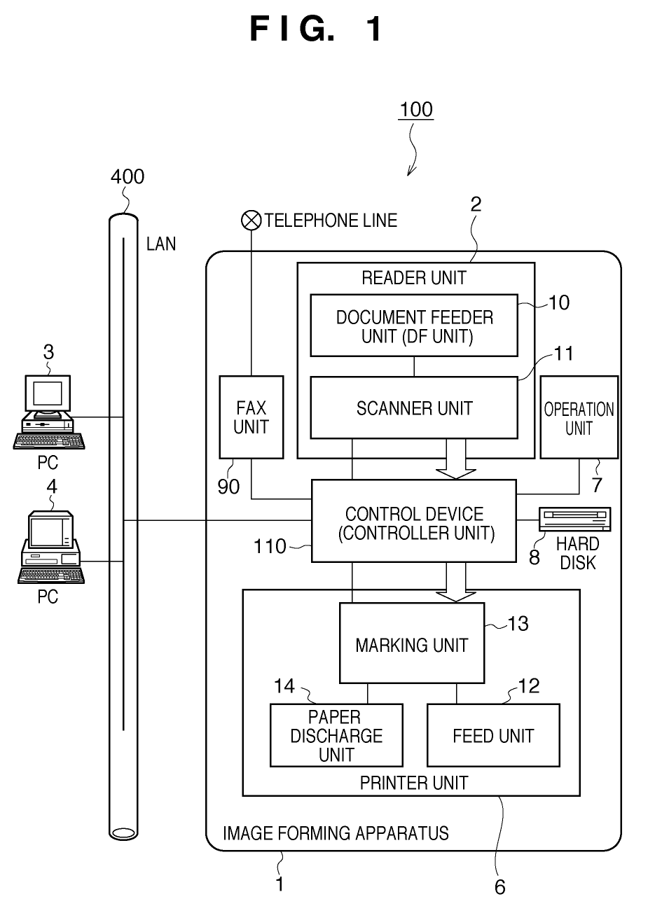

The first embodiment of the present invention will be described below with reference to FIGS. 1 to 5. The arrangement of an information processing system 100 and printer 1 of this embodiment will be described first with reference to FIG. 1. The information processing system 100 includes a printer 1 as an image forming apparatus, and host computers (to be simply referred to as PCs hereinafter) 3 and 4 as information processing apparatuses, which are connected via a LAN 400 to be able to communicate with each other. The arrangement of the information processing system 100 illustrated in FIG. 1 is an example, and does not intend to limit the present invention. That is, the information processing system 100 of the present invention may include other image forming apparatuses and other information processing apparatuses.

The printer 1 is connected to the PCs 3 and 4 via the LAN (Local Area Network) 400 such as Ethernet®. The printer 1 includes a reader unit 2 which executes reading processing of image data, a printer unit 6 which executes image formation based on image data, and an operation unit 7 which includes a keyboard used to make input/output operations of image data, and a liquid crystal panel used to display image data and various functions. Furthermore, the printer 1 includes a hard disk 8 which pre-stores control programs, image data, and the like, a FAX unit 90 which executes FAX input/output processing, and a controller unit 110 which is connected to these components and includes a single electronic component to control them.

The reader unit 2 includes a document feeder unit 10 which conveys a document sheet to a reading position, and a scanner unit 11 which optically reads a document image, and converts it into image data as an electrical signal. The printer unit 6 includes a feed unit 12 including a plurality of stages of paper cassettes storing print sheets, a marking unit 13 which transfers and fixes image data onto a print sheet, and a paper discharge unit 14 which applies sort processing and staple processing to printed print sheets, and exhausts the processed print sheets outside the printer.

<Arrangement of Controller Unit 110>

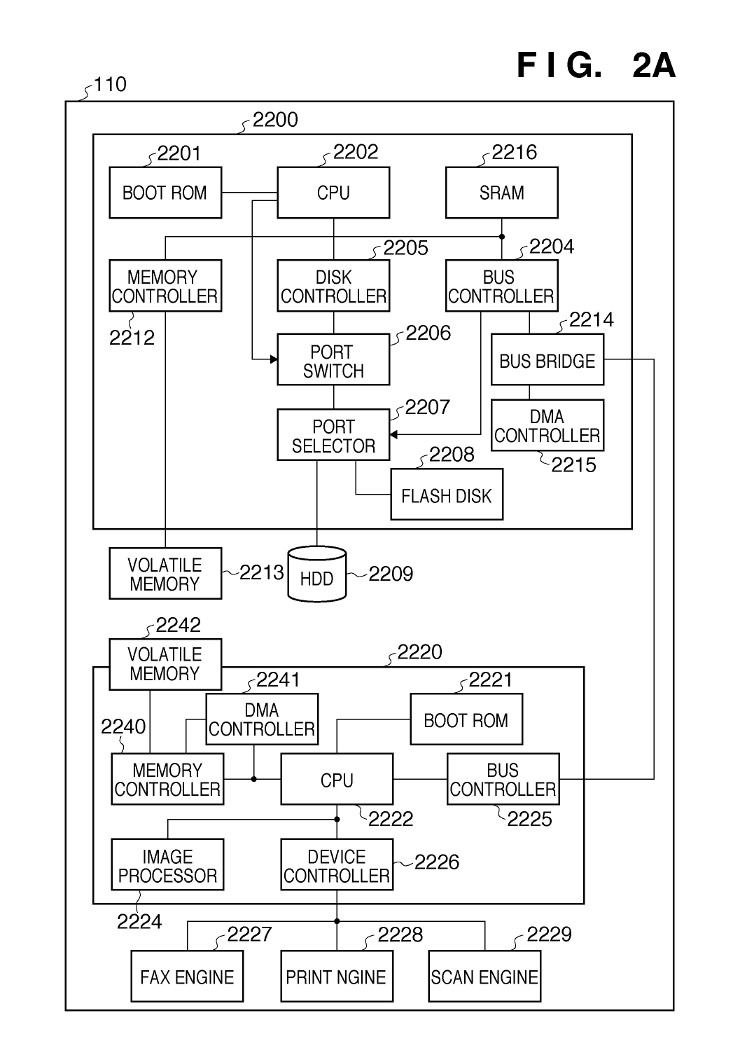

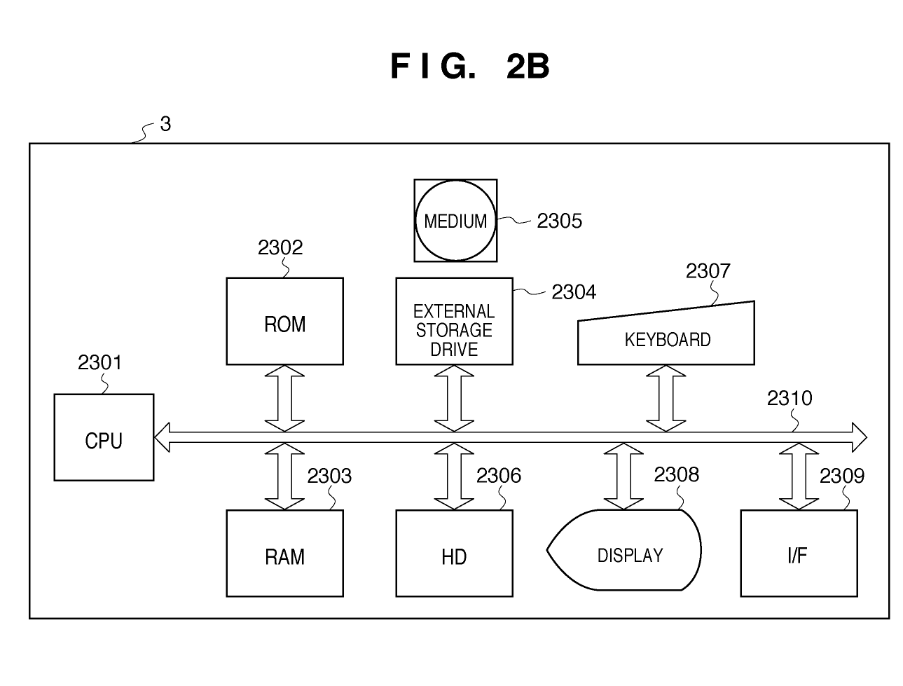

The arrangement of the controller unit 110 of the printer 1 according to this embodiment will be described below with reference to FIG. 2A. The controller unit 110 roughly includes a main CPU unit (main board) 2200 which controls general information processing, and a sub-CPU unit (sub-board) 2220 which controls image forming processing. The arrangement illustrated in FIG. 2A is an example, and the present invention may configure, for example, the main CPU unit and sub-CPU unit on a single board.

The main CPU unit 2200 includes a boot ROM 2201, CPU 2202, memory controller 2212, disk controller 2205, port switch 2206, and port selector 2207. Furthermore, the main CPU unit 2200 includes a flash disk 2208, SRAM 2216, bus controller 2204, bus bridge 2214, and DMA controller 2215. The boot ROM 2201 is a nonvolatile memory which stores a boot program. The CPU 2202 is an arithmetic device which executes the boot program and other programs. The memory controller 2212 is connected to a volatile memory 2213 which temporarily stores programs and data, and controls input/output accesses to that memory.

The bus controller 2204 controls connection with the sub-board. The disk controller 2205 is connected to the port selector 2207 via the port switch that switches accesses to devices. Furthermore a hard disk drive (HDD) 2209 and the flash disk 2208 are connected to the port selector 2207. The disk controller 2205 controls arbitrary devices selected by the port selector 2207. In FIG. 2A, the disk controller 2205, port switch 2206, and port selector 2207 are described as independent modules. However, some or all of these modules may be implemented as a single module. The bus bridge 2214 connects the main CPU unit 2200 and sub-CPU unit 2220 via a bus. The DMA controller 2215 controls memory transfer between the main CPU unit 2200 and sub-CPU unit 2220.

The sub-CPU unit 2220 includes a boot ROM 2221, CPU 2222, volatile memory 2242, memory controller 2240, bus controller 2225, image processor 2224, device controller 2226, and DMA controller 2241. The boot ROM 2221 is a nonvolatile memory which stores a boot program. The CPU 2222 is an arithmetic device which executes the boot program and other programs. The volatile memory 2242 temporarily stores programs and data. The memory controller 2240 is connected to the volatile memory 2242, and controls that memory. The bus controller 2225 controls connection with the main CPU unit 2200. The image processor 2224 executes image forming processing at high speed. The device controller 2226 is connected to a FAX engine 2227, print engine 2228, and scan engine 2229, controls these engines, and executes image forming processing. The DMA controller 2241 controls memory transfer between the main CPU unit 2200 and sub-CPU unit 2220.

<Arrangement of PC>

The hardware arrangement of the PC 3 as the information processing apparatus according to this embodiment will be described below with reference to FIG. 2B. Note that the basic arrangement of the PC 4 is the same as that of the PC 3 to be described below, and a description thereof will not be repeated. The PC 3 includes a CPU 2301, ROM 2302, RAM 2303, external storage drive 2304, HD 2306, keyboard 2307, display 2308, and network I/F 2309. The respective components are connected via a system bus 2310. A medium 2305 is loaded in the external storage drive 2304.

The CPU 2301 executes application programs, a printer driver program, an OS, a network printer control program, and the like, which are stored in the HD (Hard Disk) 2306. The CPU 2301 temporarily stores information, files, and the like required to execute programs on the RAM 2303. The ROM 2302 stores programs such as a basic I/O program, and various data such as font data and template data used in document processing. The RAM 2303 serves as a main memory, work area, and the like of the CPU 2301. The external storage drive 2304 can load programs stored in, for example, a medium to the PC 3.

The medium 2305 stores programs (printer driver) required to execute processing to be described in this embodiment, and related data. These programs and related data may be pre-stored in the HD 2306 or ROM 2302, as described above. The HD 2306 stores the application programs, printer driver program, OS, control programs, related programs, and the like. The keyboard 2307 is an input device used when the user inputs instructions such as device control commands to the PC 3. The display 2308 is a display device which displays commands input from the keyboard 2307, printer statuses, and the like. The system bus 2310 controls flows of data in the PC 3. The network interface (to be abbreviated as an I/F hereinafter) 2309 is a communication interface required to establish connection to a local area network (LAN) or the Internet. In this embodiment, the I/F 2309 is connected to the LAN 400 illustrated in FIG. 1.

<Processing Sequence of Document File>

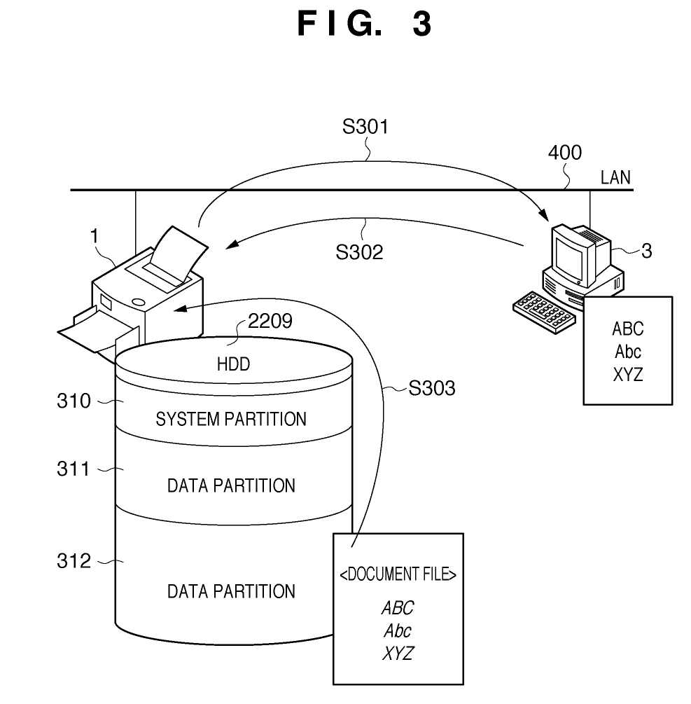

The processing sequence of a document file will be described below with reference to FIG. 3. Conventionally, upon printing a document file on a file server, a PC opens the document file, converts it into PDL data, and transfers the PDL data to a printer to print the PDL data. In this case, the PDL (Page Description Language) data is a data format required to instruct the printer to render an image. For example, the conventional PC converts a file to be printed into PDL data, and outputs that data to the printer, thus implementing the print processing. That is, since the converted PDL data has to be transferred from the PC to the printer at the time of print processing, a print performance drops.

Hence, in this embodiment, the printer 1 includes a file server, and a storage area of files to be image formed is assured in the hard disk drive 2209 in the controller unit 110. The hard disk drive 2209 includes a system partition 310 used in a program operation mode of the main CPU unit 2200, and data partitions 311 and 312 used to store, for example, data. Assume that the data partition 312 is used as a document storage area of the file server, and the PCs 3 and 4 on the single network can access the data partition 312 as the document storage area.

Therefore, according to this embodiment, upon printing a document file on the file server, the PC 3 acquires and refers to a file group on the file server included in the printer 1 in step 5301. In step S302, the PC 3 displays the acquired file group for the user to be selectable, selects a file in accordance with a user instruction, and transmits a print instruction (image forming instruction) of that file to the printer 1. After that, the printer 1 acquires that file from the hard disk drive 2209, and executes print processing.

<Print Processing>

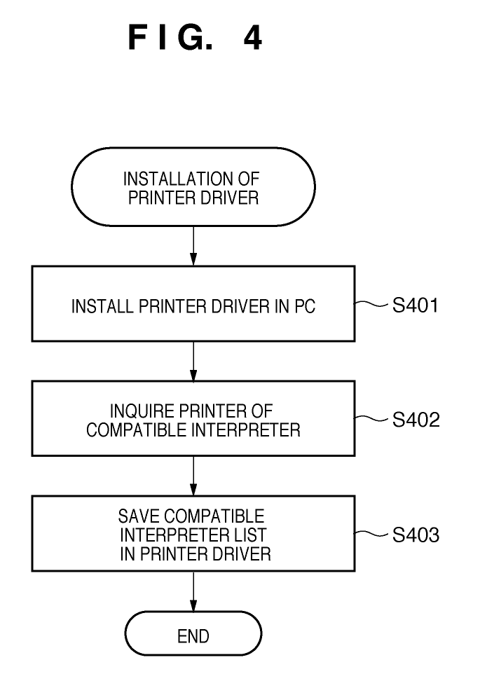

Print processing according to this embodiment will be described below. The processing sequence upon installing a printer driver of the printer 1 in the PC 3 will be described first with reference to FIG. 4. Installation of the printer driver allows the printer 1, as a target of an image forming instruction, to determine whether or not to print a designated document file. Note that the processing to be described below is systematically controlled by the CPU 2301 of the PC 3.

Upon reception of an installation instruction of a printer driver from the user, the CPU 2301 executes installation processing in step S401. More specifically, the CPU 2301 installs a printer driver stored in the medium 2305, confirms a designated printer, and sets to allow print processing from the PC 3. Upon completion of the installation of the printer driver, the printer driver acquires device information such as accessories attached to the printer 1 and paper information, and also information of interpreters (file interpreting units) of document file formats, which are included in the printer 1, in step S402. In step S403, the printer driver stores compatible interpreters of the printer 1 in, for example, the HD 2306 as device information.

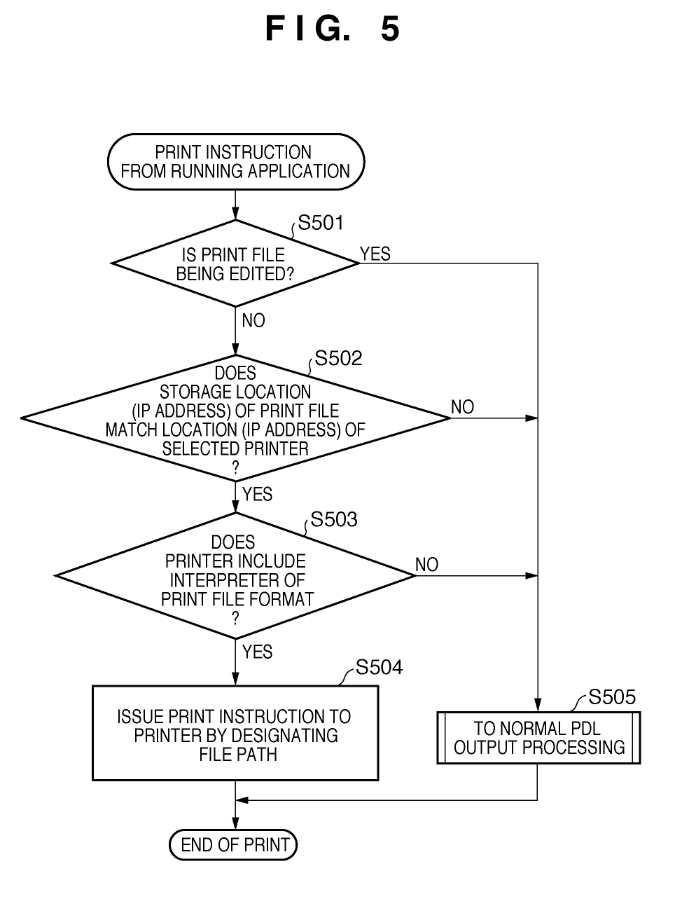

The print processing of this embodiment will be described below with reference to FIG. 5. Note that the processing to be described below is implemented when the CPU 2301 reads out the printer driver installed in FIG. 4 from, for example, the HD 2306, and executes the readout printer driver. Also, this flowchart is premised on that the printer driver has compatible interpreter information of the printer 1. As illustrated in FIG. 3, assume that the PC 3 opens a document stored in the data partition 312 of the hard disk drive 2209 of the printer 1 using application software.

The CPU 2301 functions as an acceptance unit, and accepts a print instruction of the document file by a user operation via the application that runs on the PC 3. Upon acceptance of the print instruction via the running application, the CPU 2301 determines in step S501 whether or not the document file designated by the print instruction from the user has been edited from the stored file. Note that some files are inhibited from being edited, and step S501 may be skipped in such case. If the document file has been edited, the process advances to step S505, and the CPU 2301 executes normal PDL output processing, thus ending the processing.

On the other hand, if the document file is not edited, the process advances to step S502, and the CPU 2301 determines whether or not the storage location (for example, IP address) of the document file to be printed matches the location (for example, IP address) of the selected printer 1. If the two locations do not match, the process advances to step S505, and the CPU 2301 executes normal PDL output processing, thus ending the processing.

On the other hand, if the two locations match, the process advances to step S503, and the CPU 2301 determines whether or not the format of the document file to be printed matches one of the compatible interpreters of the printer stored in step S403. That is, in this case, the CPU 2301 determines whether or not the printer 1 can interpret the format of that file. If the format does not match any of the stored interpreters, the process advances to step S505, and the CPU 2301 executes normal PDL output processing, thus ending the processing.

On the other hand, if the format matches one of the stored interpreters, the process advances to step S504, and the CPU 2301 transfers a file path (information indicating the storage location) of the document file to be printed to the printer 1, and instructs the printer 1 to execute print processing, thus ending the processing. In this case, since the data to be transferred does not include any image data of the document file, a transfer data size is much smaller than that in normal PDL print processing. After that, the printer 1 interprets the format of the document file according to the file path designated by the print instruction, and executes the print processing.

As described above, the information processing apparatus according to this embodiment is connected to the image forming apparatus which stores a plurality of files to be image formed. Upon accepting an image forming instruction of one of these files, the information processing apparatus determines whether or not the image forming apparatus can interpret the format of the designated file. If the image forming apparatus can interpret the format, the information processing apparatus issues an image forming instruction to the image forming apparatus by designating the storage location of the file. On the other hand, if the image forming apparatus cannot interpret the format of the file, the information processing apparatus transmits data (for example, PDL data) converted into a format that the image forming apparatus can interpret to the image forming apparatus, and issues an image forming instruction to the image forming apparatus. In this way, when the image forming apparatus can interpret the format of the file which is to undergo image formation, the information processing apparatus according to this embodiment issues an image forming instruction to the image forming apparatus by designating only the file path without transmitting any data of the file to the image forming apparatus. Therefore, the network load can be reduced, and the throughput of the image forming apparatus can be improved. In this embodiment, since the image forming apparatus includes the file server, the need for individual pull-print settings using the file server by the user can be obviated, thus reducing user operations.

Note that the present invention is not limited to the aforementioned embodiment, and various modifications may be made. For example, the information processing apparatus may include, for example, an HDD which pre-stores file formats that can be interpreted by the image forming apparatus. In this case, for example, upon installing the printer driver, the information processing apparatus desirably acquires information indicating interpretable file formats from the target image processing and stores it in the HDD. Then, the information processing apparatus can easily determine using this information whether or not the image forming apparatus can interpret the format of a file, an image forming instruction of which is accepted.

The information processing apparatus may determine whether or not a file, an image forming instruction of which is accepted, has been edited by an application which runs on the information processing apparatus. If the file has been edited, the information processing apparatus may convert the edited data into PDL data, and may transmit that data to the image forming apparatus. Then, the information processing apparatus can surely execute print processing using data intended by the user.

The information processing apparatus may determine whether or not the address of an image forming apparatus where a file, an image forming instruction of which is accepted, matches that of an image forming apparatus as a target of the image forming instruction. In this case, if the two addresses do not match, the information processing apparatus may convert the file into PDL data and may transmit the data to the image forming apparatus which forms an image of that file. With this control, according to this embodiment, even when an apparatus which stores files is different from an apparatus which executes image formation, image formation can be surely performed.

### Second Embodiment

The second embodiment will be described below. The first embodiment adopts the method which performs normal PDL output processing when a document file to be printed is being edited. This embodiment will explain control for executing print processing after a document file to be printed, which is being edited, is temporarily stored.

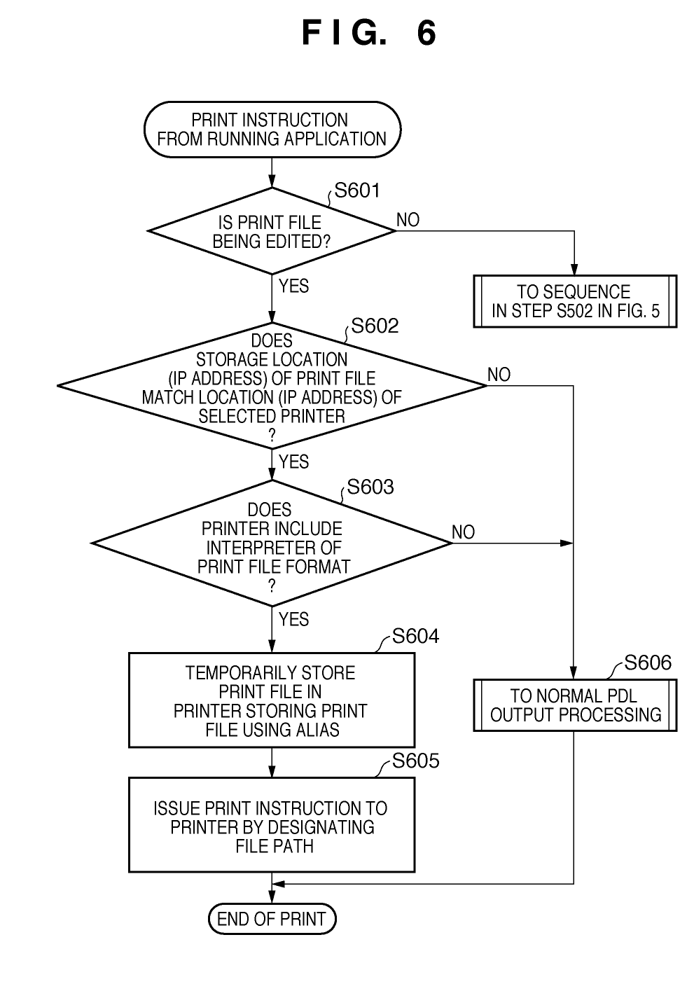

The print processing according to this embodiment will be described below with reference to FIG. 6. Note that the processing to be described below is implemented when a CPU 2301 reads out a printer driver installed in FIG. 4 from, for example, an HD 2306, and executes the readout printer driver. Assume that the printer driver stores compatible interpreter information of a printer by the method described in FIG. 4. Also, assume that a PC 3 opens a document, which is stored in a data partition 312 of a hard disk drive 2209 of a printer 1, using application software, as illustrated in FIG. 3.

Upon acceptance of a print instruction via a running application, the CPU 2301 determines in step S601 whether or not the document file designated by the print instruction from the user has been edited from the stored file. If the document file is not edited, the process advances to the process in step S502 in FIG. 5. On the other hand, if the document file has been edited, the process advances to step S602, and the CPU 2301 determines whether or not the storage location (for example, IP address) of the document file to be printed matches the location (for example, IP address) of the selected printer 1. If the two locations do not match, the process advances to step S606, and the CPU 2301 executes normal PDL output processing, thus ending the processing.

On the other hand, if the two locations match, the process advances to step S603, and the CPU 2301 determines whether or not the format of the document file to be printed matches one of the compatible interpreters of the printer stored in step S403. If the format does not match any of the stored interpreters, the process advances to step S606, and the CPU 2301 executes normal PDL output processing, thus ending the processing.

On the other hand, if the format matches one of the stored interpreters, the process advances to step S604, and the CPU 2301 controls the printer 1, which stores the document file to be printed, to temporarily store that document file to be printed using an alias. In step S605, the CPU 2301 transfers a file path of the temporarily stored document file to be printed to the printer 1, and instructs the printer 1 to execute print processing, thus ending the processing. After that, the printer 1 interprets the format of the document file according to the file path designated by the print instruction, and executes the print processing. Upon completion of the print processing, the printer 1 deletes the file temporarily stored using the alias.

As described above, even when a file, an image forming instruction of which is accepted, has been edited, the information processing apparatus according to this embodiment transmits the edited data to the image forming apparatus and controls the image forming apparatus to temporarily store that data as long as the image forming apparatus can interpret the format of that file. Furthermore, the information processing apparatus issues an image forming instruction to the image forming apparatus by designating the storage location of the temporarily stored data. In this way, even when a file, an image forming instruction of which is accepted, has been edited, the information processing apparatus can improve the throughput of the image forming apparatus at the time of image formation.

### Third Embodiment

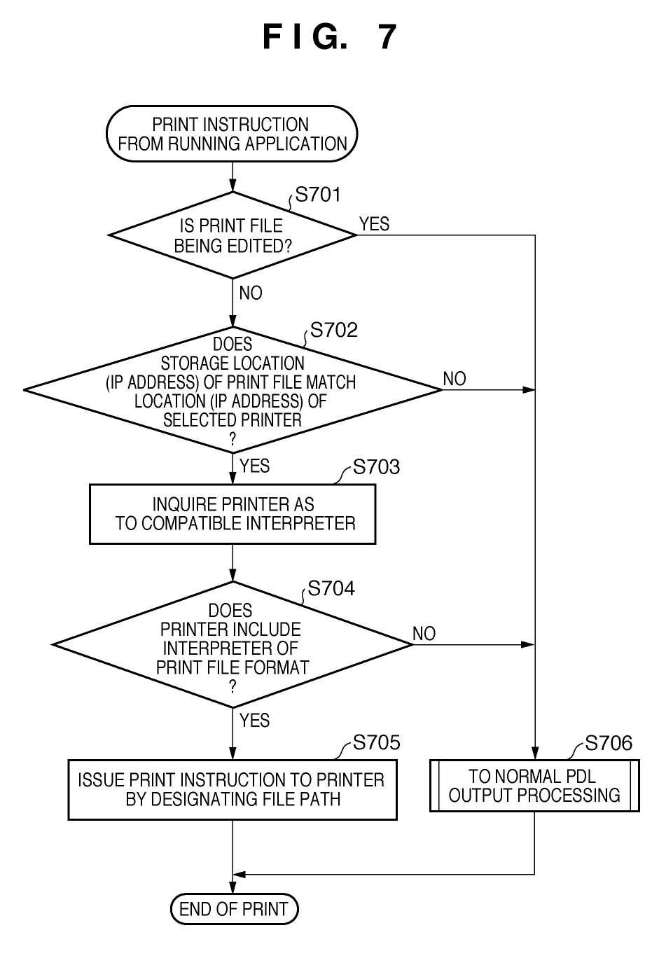

The third embodiment will be described below. This embodiment will explain control which inquires a printer 1 at the time of print processing as to whether or not the printer 1 has an interpreter (file interpreting unit) compatible with a document file to be printed, unlike in the above embodiments. Print processing according to this embodiment will be described below with reference to FIG. 7. Note that the processing to be described below is implemented when a CPU 2301 reads out a printer driver installed in FIG. 4 from, for example, an HD 2306, and executes the readout printer driver. Also, assume that a PC 3 opens a document, which is stored in a data partition 312 of a hard disk drive 2209 of a printer 1, using application software, as illustrated in FIG. 3.

Upon acceptance of a print instruction via a running application, the CPU 2301 determines in step S701 whether or not the document file designated by the print instruction from the user has been edited from the stored file. If the document file has been edited, the process advances to step S706, and the CPU 2301 executes normal PDL output processing, thus ending the processing.

On the other hand, if the document file is not edited, the process advances to step S702, and the CPU 2301 determines whether or not the storage location (for example, IP address) of the document file to be printed matches the location (for example, IP address) of the selected printer 1. If the two locations do not match, the process advances to step S706, and the CPU 2301 executes normal PDL output processing, thus ending the processing.

On the other hand, if the two locations match, the process advances to step S703, and the CPU 2301 acquires information of interpreters (file interpreting units) which are included in the printer 1 and are associated with document file formats. Then, the CPU 2301 then determines in step S704 whether or not the format of the document file to be printed matches one of the compatible interpreters of the printer 1 in the information acquired in step S703. If the format does not match any of the stored interpreters, the process advances to step S706, and the CPU 2301 executes normal PDL output processing, thus ending the processing.

On the other hand, if the format matches one of the stored interpreters, the process advances to step S705, and the CPU 2301 transfers a file path of the document file to be printed to the printer 1, and instructs the printer 1 to execute print processing, thus ending the processing. As described above, since the data to be transferred does not include any image data of the document file, a transfer data size is much smaller than that in normal PDL print processing. After that, the printer 1 interprets the format of the document file according to the file path designated by the print instruction, and executes the print processing.

As described above, after the image forming instruction is accepted, the information processing apparatus according to this embodiment acquires information indicating whether or not the image forming apparatus can interpret the format of the file, and determines it. In this way, since the information processing apparatus of this embodiment acquires information required to determine whether or not the image forming apparatus can interpret the format of the file from the image forming apparatus, memory resources can be effectively used. Furthermore, the performance of the image forming apparatus can be recognized in real time. Also, this embodiment allows various modifications. For example, this embodiment may be combined with the second embodiment at the time of implementation.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-218005 filed on Sep. 18, 2009, which is hereby incorporated by reference herein in its entirety.

What is claimed is:

1. An information processing apparatus connected to an image forming apparatus which stores a plurality of files, said information processing apparatus comprising:
an acceptance unit that accepts, from a user, an image forming instruction of a file stored in the image forming apparatus;
a determination unit that determines whether or not the image forming apparatus is configured to interpret a format of the file, the image forming instruction of which is accepted; and
an instruction unit that issues, when the image forming apparatus is configured to interpret the format of the file, an image forming instruction to the image forming apparatus by designating a storage location of the file in the image forming apparatus without acquiring the file from the image forming apparatus, and converts, when the image forming apparatus is not configured to interpret the format of the file, the file acquired from the image forming apparatus into a format that the image forming apparatus is configured to interpret, transmits the converted data to the image forming apparatus, and issues an image forming instruction of the converted data to the image forming apparatus.

2. The apparatus according to claim 1, further comprising:
a storage unit that stores, in advance, file formats that the image forming apparatus is configured to interpret,
wherein said determination unit determines whether or not the image forming apparatus is configured to interpret the format of the file, the image forming instruction of which is accepted, by determining whether or not the file formats stored in said storage unit include the format of the file, the image forming instruction of which is accepted.

3. The apparatus according to claim 1, wherein said determination unit comprises an acquisition unit that acquires file formats that the image forming apparatus is configured to interpret from the image forming apparatus, and
said determination unit determines whether or not the image forming apparatus is configured to interpret the format of the file, the image forming instruction of which is accepted, by determining whether or not the acquired file formats include the format of the file, the image forming instruction of which is accepted.

4. The apparatus according to claim 1, further comprising:
a unit that determines whether or not the file, the image forming instruction of which is accepted, has been edited in said information processing apparatus,
wherein when the file, the image forming instruction of which is accepted, has been edited, said instruction unit converts the format of the edited file into a format that the image forming apparatus is configured to interpret, transmits the converted data to the image forming apparatus, and issues an image forming instruction to the image forming apparatus.

5. The apparatus according to claim 1, further comprising:
a unit that determines whether or not the file, the image forming instruction of which is accepted, has been edited in said information processing apparatus,
wherein when the file, the image forming instruction of which is accepted, has been edited, and when the image forming apparatus is configured to interpret the format of the file, said instruction unit transmits data of the edited file to the image forming apparatus to control the image forming apparatus to temporarily store the data, and issues an image forming instruction to the image forming apparatus by designating a storage location of the file temporarily stored in the image forming apparatus.

6. The apparatus according to claim 1, further comprising:
a unit that determines whether or not an address of an image forming apparatus which stores the file, the image forming instruction of which is accepted, matches an address of an image forming apparatus as a target of the image forming instruction,
wherein when the two addresses do not match, said instruction unit transmits data obtained by converting the file into a format that the image forming apparatus is configured to interpret to the image forming apparatus as the target of the image forming instruction, and issues an image forming instruction to that image forming apparatus.

7. A control method of an information processing apparatus connected to an image forming apparatus which stores a plurality of files to be image formed, the method executing:
controlling an acceptance unit to accept, from a user, an image forming instruction of a file stored in the image forming apparatus;
controlling a determination unit to determine whether or not the image forming apparatus is configured to interpret a format of the file, the image forming instruction of which is accepted; and
controlling an instruction unit to issue, when the image forming apparatus is configured to interpret the format of the file, an image forming instruction to the image forming apparatus by designating a storage location of the file in the image forming apparatus without acquiring the file from the image forming apparatus, and to convert, when the image forming apparatus is not configured to interpret the format of the file, the file acquired from the image forming apparatus into a format that the image forming apparatus is configured to interpret, transmit the converted data to the image forming apparatus, and issue an image forming instruction of the converted data to the image forming apparatus.

8. A computer-readable storage medium storing a computer program for making a computer execute a control method of an information processing apparatus according to claim 7.
